(19) United States
(12) Patent Application Publication
(10) Pub. No.: US 2015/0313176 A1
(43) Pub. Date: Nov. 5, 2015

(54) Pet Feeding System

(71) Applicant: Lori Gelinas, Land O'Lakes, FL (US)

(72) Inventor: Lori Gelinas, Land O'Lakes, FL (US)

(21) Appl. No.: 14/266,640

(22) Filed: Apr. 30, 2014

(51) Int. Cl. A01K 5/01; A01K 29/00; B66F 3/08; A01K 7/00

(52) U.S. Cl. CPC A01K 5/0114; A01K 7/00; A01K 29/00; B66F 3/08

(57) ABSTRACT

A pet feeding system that is operable to facilitate the service of the bowls forming a part thereof by providing movement of the bowls to a vertically enhanced position. The pet feeding system includes a housing supported by a base plate wherein the housing is vertical in orientation and further includes an interior volume. A lift tray assembly is provided having a horizontal support plate that includes two apertures operable to receive a food bowl and a water bowl therein. The lift tray assembly is operably coupled to a jack screw that is rotatably mounted within the housing. A motor is operable to rotate the jack screw in a first direction and a second direction so as to move the lift tray assembly in an upwards and downwards direction. A control switch and remote controller provide user interface for operation of the pet feeding system.

### PRIORITY UNDER 35 U.S.C Section 119(e) & 37 C.F.R. Section 1.78

This nonprovisional application claims priority based upon the following prior U.S. Provisional Patent Application entitled: Pet Feeding System, Application No.:61/835,136, filed Jun. 14, 2013, in the name of Lori A. Gelinas which is hereby incorporated by reference for all purposes.

### FIELD OF THE INVENTION

The present invention relates to a pet feeding system and more particularly pertains to a pet feeding system that is operable to raise and lower a set of bowls. The raising and lowering of the bowls adapted for the convenience of the pet owner when servicing the bowls wherein the raised position of the bowls facilitates easier access thereto. The pet accesses the bowls when the bowls are in the lowered position.

### BACKGROUND

There are numerous types of pet bowls that are operable to provide food and drink to domestic pets such as but not limited to dogs and cats. Typically most pet owners will place the pet bowls on the floor and will have to service the bowls on the floor. This can create issues for those pet owners that have physical disabilities or other conditions that inhibit access to the pet bowls. Accordingly, there is a need for a pet bowl that is operable to assist a pet owner in servicing the pet bowl wherein the pet bowl can be raised and lowered for easier access thereto by the pet owner.

### SUMMARY OF THE INVENTION

In view of the disadvantages inherent in the known types of feeding systems of known designs and configurations now present in the prior art, the present invention provides an improved pet feeding system. As such, the general purpose of the present invention, which will be described subsequently in greater detail, is to provide a new and improved pet feeding system and method, which has all the advantages of the prior art and none of the disadvantages.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the invention be regarded as including such equivalent constructions insofar as they do not depart from the spirit and scope of the present invention.

For a better understanding of the invention, its operating advantages and the specific objects attained by its uses, reference should be had to the accompanying drawings and descriptive matter in which there is illustrated preferred embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a perspective illustration of a pet feeding system constructed in accordance with the principles of the present invention

FIG. 2 is a cross-sectional view taken at line 2-2 of FIG. 1.

FIG. 3 is an enlarged cross-sectional view taken at Circle 3 of FIG. 2.

FIG. 4 is a rear-elevational view of the system with parts broken away to show certain internal constructions thereof.

FIG. 5 is a plan view of remote controls for the system of the prior figure.

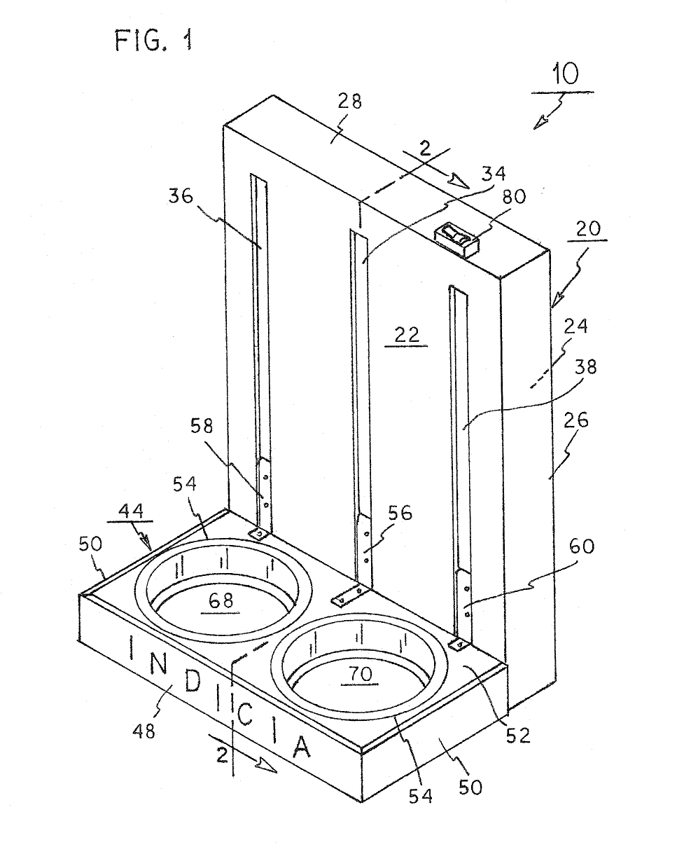

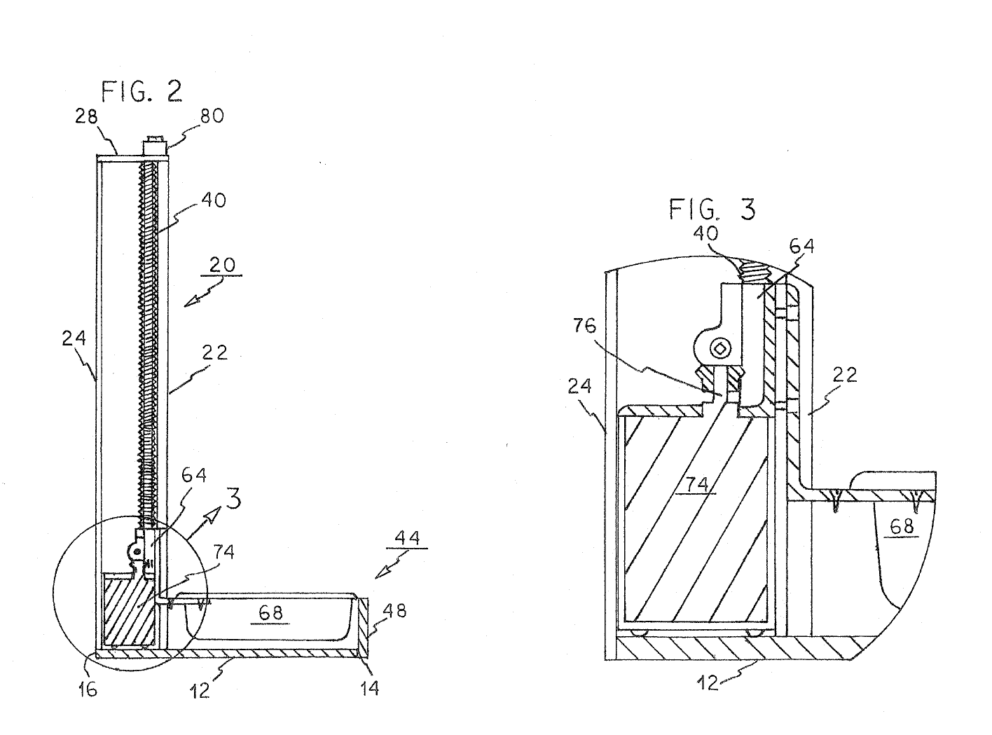

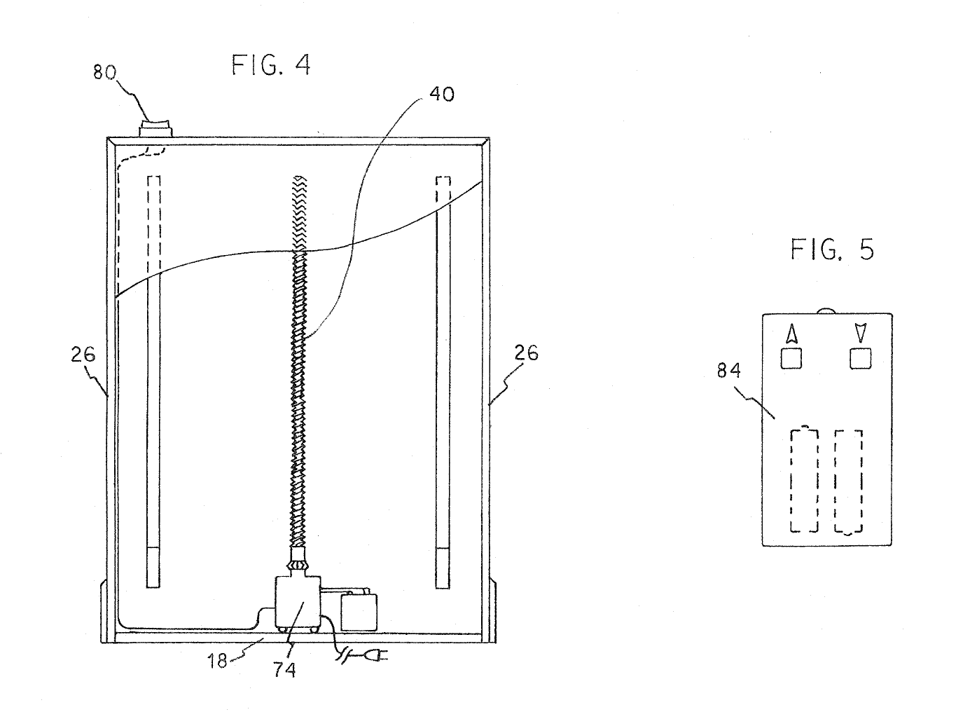

### DETAILED DESCRIPTION

Referring now to the drawings submitted herewith, wherein various elements depicted therein are not necessarily drawn to scale and wherein through the views and figures like elements are referenced with identical reference numerals, there is illustrated a pet feeding system 10 constructed according to the principles of the present invention.

The present invention, the pet feeding system 10 is comprised of a plurality of components. Such components are individually configured and correlated with respect to each other so as to attain the desired objective. In their broadest context such include a base plate 12, a housing 20, a lift tray assembly 44 and a follower 64. In this broad context, first provided is a base plate 12. A housing 20 has vertical front plate 22 and vertical rear plate 24, vertical side plates 26 and a horizontal top plate 28. Slots are provided in the front plate 22. The housing 20 extends upwardly from the base plate. A jack screw 40 is provided within the housing 20. The upper end is rotatably received in the top plate 28.

A lift tray assembly 44 has vertical interior and exterior plates and a horizontal support plate 52 with two apertures 54. A central bracket 56 and lateral brackets 58,60 are attached to the support plate 52 and slidably received in the slots.

A follower 64 mounted within the housing 20 is threadedly received on the jack screw 40. In this manner the lift tray assembly 44 may be raised and lowered in response to rotation of the jack screw 40. Such components are individually configured and correlated with respect to each other so as to attain the desired objective.

In the preferred embodiment of the pet feeding system 10, first provided is a base plate 12. The base plate 12 is in a rectangular configuration. The base plate 12 has a forward edge 14. The base plate 12 has a rearward edge 16. The base plate 12 also has parallel side edges 18. The side edges 18 are provided between the forward edge 14 and rearward edge 16. The base plate 12 is positionable upon a recipient surface.

A housing 20 is provided. The housing 20 is in a rectilinear configuration. The housing 20 has a vertical front plate 22. The housing 20 has a vertical rear plate 24. The housing 20 has vertical side plates 26. The housing 20 also has a horizontal top plate 28 and a horizontal bottom plate. The bottom plate is an extension of the base plate 12. The front plate 22 of the housing 20 has three vertical slots. The vertical slots include a central slot 34. The vertical slots also include two lateral slots 36, 38. While a central slot 34 and two lateral slots 36, 38 are present in the preferred embodiment of the pet feeding system 10, it is contemplated within the scope of the present invention that the front plate 22 could be configured with as few as one central slot 34. A jack screw 40 is provided. The jack screw 40 is provided within the housing 20. The jack screw 40 has an upper end. The upper end of the jack screw 40 is rotatably received in the upper plate of the housing 20 and the lower end in proximity to the base plate.

A lift tray assembly 44 is provided next. The lift tray assembly 44 is in a generally rectilinear configuration. The lift tray assembly 44 includes an exterior plate 48. The lift tray assembly 44 also includes parallel lateral plates 50 and a horizontal support plate 52. The horizontal support plate 52 has two apertures 54. The lift tray assembly 44 includes three laterally spaced brackets. The brackets include a central bracket 56. The brackets also include two lateral brackets 58, 60. The brackets are attached to the horizontal support plate 52. The brackets are slidably received in the slots of the housing 20. In this manner the lift tray assembly 44 is guided during vertical movements.

Also provided is a follower 64. The follower 64 is provided within the housing 20. The follower 64 is threadedly received on the jack screw 40. The follower 64 is coupled to the lift tray assembly 44 via central bracket 56. In this manner the lift tray assembly 44 is raised and lowered in response to rotation of the jack screw 40.

Provided next is a water bowl 68. A similarly configured food bowl 70 is provided. The food bowl 70 and water bowl 68 are generally cylindrical configuration. The food bowl 70 and water bowl 68 have a closed bottom. The food bowl 70 and water bowl 68 have an open top. The food bowl 70 and water bowl 68 are removably received and supported in the apertures 54. While the pet feeding system 10 includes a food bowl 70 and a water bowl 68, it is contemplated within the scope of the present invention that the pet feeding system 10 could have as few as one bowl or more than two bowls.

Further provided is a drive motor 74. The drive motor 74 is within the housing 20. The drive motor 74 is supported by the base plate 12. The drive motor 74 has a drive shaft 76. The drive shaft 76 is rotatable around a vertical axis. The drive shaft 76 is operatively coupled with the jack screw 40. In this manner the jack screw 40 is rotated. Further in this manner the raising and lowering of the follower 64 and lift tray assembly 44 is caused.

Provided last is the control switch 80. The control switch 80 is coupled to the drive motor 74 and is rotated in a first direction. Also in this manner the follower 64, lift tray assembly 44 and trays are raised to an elevated orientation for a pet owner to fill the bowls with water and food. Further in this manner the food bowl 70 and water bowl 68 are raised without undue bending. The control switch 80 is adapted to rotate the motor in a second direction. Rotation in the second direction lowers the trays. In this manner a pet may conveniently consume food and water with the food bowl 70 and water bowl 68 lowered. The control switch 80 is coupled to a conventional electrical cord. In this manner the drive motor 74 is powered from an alternating current source. The pet feeding system 10 further includes a supplemental handheld controller 84. In this manner the follower 64, lift tray assembly 44, and food bowl 70 and water bowl 68 may be remotely raised and lowered.

As to the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specifications are intended to be encompassed by the present invention.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A pet feeding system comprising:
a base plate, said base plate being rectangular in shape and horizontal in manner;
a housing, said housing having a plurality of walls integrally formed to create an interior volume, said housing being operably coupled to said base plate, said housing being vertical in orientation, said plurality of walls including a front plate;
a lift tray assembly, said lift tray assembly movably coupled to said housing, said lift tray assembly configured to receive at least one bowl, said lift tray assembly operable to move in a upward-downward movement adjacent said front plate;
a drive motor, said drive motor disposed within said housing, said drive motor operably coupled to said lift tray assembly, said drive motor operable to move said lift tray assembly.

2. The pet feeding system as recited in claim 1, and further including a jack screw, said jack screw being operably coupled to said lift tray assembly and said drive motor, said jack screw operable to facilitate the upward-downward movement of the lift tray assembly.

3. The pet feeding system as recited in claim 2, and further including a follower, said follower being threadably coupled to said jack screw, said follower operable to couple the jack screw and the lift tray assembly.

4. The pet feeding system as recited in claim 3, and further including at least one slot, said at least one slot being present in said front plate of said housing.

5. The pet feeding system as recited in claim 4, and further including at least one bracket, said at least one bracket being slidably mounted within said at least one slot, said at least one bracket operably coupled to said follower and said lift tray assembly.

6. The pet feeding system as recited in claim 5, wherein said lift tray assembly further includes a horizontal plate, said horizontal plate having at least one aperture, said at least one aperture operable to receive a bowl therein.

7. The pet feeding system as recited in claim 6, and further including a control switch, said control switch operably coupled to said drive motor, said control switch operable to power said drive motor so as to rotate said jack screw in a first direction and a second direction.

8. A pet feeding system operable to facilitate the easier filling of food and water bowls forming a part of the pet feeding system comprising:
a housing, said housing having an upper end and a lower end, said housing having a plurality of walls integrally formed, said plurality of walls defining an interior volume, said housing being vertical in orientation, said plurality of walls further including a front plate, said front plate having therein a plurality of slots, said plurality of slots extending substantially between said upper end and said lower end of said housing;
a base plate, said base plate being secured to said housing, said base plate being perpendicular to said housing, said base plate operable to provide support for said housing, said base plate being planar in manner and rectangular in shape;
a lift tray assembly, said lift tray assembly being movably mounted to said housing, said lift tray assembly including a horizontal support plate, said lift tray assembly operable to move intermediate said lower end and said upper end of said housing;
a drive motor, said drive motor being disposed within said housing, said drive motor being operably coupled to said lift tray assembly, said drive motor operable to move said lift tray assembly intermediate said lower end of said housing and said upper end of said housing; and
wherein the pet feeding system is operable to position the lift tray assembly proximate said upper end of said housing so as to facilitate the filling of at least one bowl secured to said horizontal support plate.

9. The pet feeding system as recited in claim 8, and further including a jack screw, said jack screw being operably coupled to said drive motor, said jack screw being rotatably coupled within said housing, said jack screw operable to rotate in a first direction and a second direction so as to facilitate the movement of said lift tray assembly.

10. The pet feeding system as recited in claim 9, and further including a drive motor, said drive motor disposed within the interior volume of said housing proximate said lower end, said drive motor operably coupled to said jack screw.

11. The pet feeding system as recited in claim 10, and further including a follower, said follower being threadably coupled to said jack screw, said follower operable to couple the jack screw and the lift tray assembly.

12. The pet feeding system as recited in claim 10, and further including a plurality of brackets, wherein one of said plurality of brackets is operably coupled to said follower and said lift tray assembly, said plurality of brackets being slidably mounted within said plurality of slots.

13. The pet feeding system as recited in claim 12, wherein said horizontal support plate of said lift tray assembly further includes a first aperture and a second aperture, said first aperture and said second aperture operable to releasably secure a first bowl and a second bowl.

14. The pet feeding system as recited in claim 13, and further including a drive shaft, said drive shaft operably coupled to said drive motor and said jack screw.

15. A pet feeding system that is operable to position a first bowl and a second bowl in a vertically enhanced position so as to facilitate the service thereof and return the first bowl and the second bowl to a lower position subsequent service comprising:
a housing, said housing having a front plate and a rear plate parallel in manner, said front plate having a lower end and an upper end, said housing having a first side plate and a second side plate, said front plate, rear plate, first side plate and said second side plate being integrally formed, said housing having an interior volume, said housing being rectangular in shape, said housing being vertical in orientation, said front plate further including three slots therein, said three slots extending intermediate said lower end and said upper end of said front plate, said three slots including a central slot and a first lateral slot and a second lateral slot on opposing sides of said central slot;
a base plate, said base plate operably coupled to said housing being perpendicular thereto, said base plate extending outward from said front plate, said base plate providing support for said housing;
a lift tray assembly, said lift tray assembly movably coupled to said housing, said lift tray assembly further including a horizontal support plate, said horizontal support plate having a first aperture and a second aperture, said lift tray assembly operable to move between a first position and a second position;
a jack screw, said jack screw disposed within said housing, said jack screw operably coupled to said lift tray assembly, said jack screw being rotatable in a first direction and a second direction so as to facilitate the movement of said lift tray assembly intermediate said first position and said second position;
a drive motor, said drive motor disposed within said housing, said drive motor operably coupled to said jack screw, said drive motor operable to rotate said jack screw in a first direction and a second direction; and
wherein in said first position said lift tray assembly is proximate said base plate and in said second position said lift tray assembly is distal to said base plate and vertically higher than in said first position.

16. The pet feeding system as recited in claim 15, and further including a follower, said follower being mounted to said jack screw, said follower operably coupling said jack screw to said lift tray assembly.

17. The pet feeding system as recited in claim 16, and further including three brackets, said three brackets being slidably mounted within said three slots, wherein one of said three brackets is operably coupled to said follower so as to operably couple said follower with said lift tray assembly.

18. The pet feeding system as recited in claim 17, and further including a first bowl and a second bowl, said first bowl and said second bowl being releasably secured within said first aperture and said second aperture respectively.

19. The pet feeding system as recited in claim 18, and further including a remote controller, said remote controller providing remote operation of the pet feeding system.

20. The pet feeding system as recited in claim 19, and further including a control switch, said control switch mounted to an upper end of said housing, said control switch operable to provide power to said drive motor.
